(19) United States
(12) Patent Application Publication
(10) Pub. No.: US 2025/0374852 A1
(43) Pub. Date: Dec. 11, 2025

(54) SYSTEM FOR VARIABLE RATE SEEDING

(71) Applicant: Nutrien AG Solutions, Inc., Loveland, CO (US)

(72) Inventors: Mark William Kinsey, West Lafayette, IN (US); Wade Adam Kent, Mason City, IA (US)

(21) Appl. No.: 19/227,956

(22) Filed: Jun. 4, 2025

Related U.S. Application Data
(60) Provisional application No. 63/656,417, filed on Jun. 5, 2024.

(51) Int. Cl. A01C 7/10; G05B 19/416

(52) U.S. Cl. CPC A01C 7/102; G05B 19/416; G05B 2219/37371

(57) ABSTRACT

Agricultural equipment in accordance with embodiments comprises a planter for planting crop seeds, a GPS receiver for receiving field location data and a computer system coupled to the planter and the GPS receiver. The computer system includes memory for storing a shapefile and a processor. The shapefile defines a seeding rate as a function of field location, and the seeding rate is a distribution based upon wetness levels. The processor controls the planter based upon the field location data and the shapefile. Embodiments of the shapefile define a bimodal distribution of seeding rates as a function of wetness levels, such as for example a U-shaped bimodal function or an inverted U-shaped bimodal function.

### CROSS-REFERENCE TO RELATED PATENT APPLICATIONS

This application claims the benefit of U.S. Provisional Patent Application No. 63/656,417, filed Jun. 5, 2024, the entire content and disclosure of which is incorporated herein by reference and for all purposes.

### FIELD

This disclosure relates generally to agricultural planting equipment and methods. Embodiments include equipment and methods for optimizing seeding rates.

### BACKGROUND

With high acreage monoculture farming, there is a continuing need for improved planting methods to increase crop yield and to minimize the costs of associated inputs. Systems and methods which use more accessible, cost-effective features and maximize the potential yield of a given field in a cost-effective manner would be advantageous. Systems and methods of these types suitable for certain crops such as soybeans would be especially desirable

### SUMMARY

This disclosure describes improved seed planting equipment and methods that can optimize crop yields, through the combination of crop-informed seeding rates as well as field-informed division. This is accomplished by one example via agricultural equipment including a computer system programmed to plant crops, comprising: a planter for planting crop seeds; a GPS receiver for receiving field location data; and a computer system coupled to the planter and the GPS receiver. The computer system may include memory for storing a shapefile, and a processor for controlling the planter based upon the field location data and the shapefile. The shapefile defines a distribution of seeding rates based upon wetness levels of locations in the field. Embodiments include bimodal distributions of seeding rates based upon wetness levels. The bimodal distributions may, for example, be based upon a baseline seeding rate such as that suggested by the seed supplier.

In embodiments of another example, the generation of the seeding rates comprises receiving, by one or more processors, topographical wetness index data representative of wetness levels at locations on an agricultural field; receiving, by the one or more processors, a baseline seeding rate of a crop to be planted on the agricultural field; generating, by the one or more processors, a seeding distribution function for the agricultural field based upon the topographical wetness index data and the baseline seeding rate, wherein the seeding distribution function is a bimodal function describing seeding rate as a function of wetness levels. In embodiments, the seeding distribution function is a U-shaped bimodal function. For example, the bimodal distribution function may have two relative maximums and a minimum. In embodiments, the two relative maximums may be greater than the baseline seeding rate, and the minimum may be less than the baseline seeding rate. In some embodiments the two relative maximums may be the same. The U-shaped bimodal function can be used with certain types of crops, such as for example soybeans.

In embodiments, the seeding distribution function is a discrete function comprising a plurality of discrete seeding rates. In such embodiments, the seeding distribution function may consist of three discrete seeding rates, including a first seeding rate corresponding to the baseline seeding rate, two second seeding rates corresponding to an amount greater than the baseline seeding rate by a first predetermined amount (e.g., +15-20% from baseline; the two relative maximums), and a third seeding rate corresponding to an amount less than the baseline seeding rate by a second predetermined amount (e.g., −15-20% from baseline; the minimum). The first and second predetermined amounts may be percentage values. The first and second predetermined amounts may be determined using the same percentage values. The first and second predetermined amounts may be specified values (e.g., 15-20 k from baseline). In embodiments, the distribution of seeding rates is adjusted based upon in-field variables, such as pH or altitude.

In embodiments, the seeding distribution includes a baseline seeding rate with four breaks, such that the highest and lowest (wettest and driest) wetness soil regions are prescribed the relative maximum seeding rates, the second from driest receives the baseline seeding rate, and the second from wettest receives the minimum seeding rate.

In embodiments, the bimodal distribution function is an inverted U-shaped function. For example, the inverted bimodal distribution function may have two relative minimums and a maximum. The bimodal distribution with the inverted U-shape may be used with certain crops, such as for example corn or other cereal crops.

In embodiments of another example, the generation of the field regions comprises receiving, by one or more processors, Lidar data for the field, and terrain analysis data for the field, and generating the topographical wetness index data comprises generating the topographical wetness index data based upon the Lidar data and the terrain analysis data. Embodiments may also include receiving, by the one or more processors, field location data, optionally GPS data; and generating, by the one or more processors based upon the field location data and the seeding distribution function, a shapefile representative of seeding rate based on location in the field.

In embodiments of another example, the shapefile is transmitted to a computer system of agricultural equipment configured to plant a crop. The equipment may be operated by receiving, by the computer system, location data representative of a location of the agricultural equipment on the field, optionally GPS data; and operating the computer system of the agricultural equipment based upon the location data and the shapefile to plant the crop.

This summary is provided to introduce a selection of concepts in a simplified form that are further described below in the Detailed Description. This summary is not intended to identify key features or essential features of the claimed subject matter, nor is it intended to be used to limit the scope of the claimed subject matter

### BRIEF DESCRIPTION OF THE DRAWINGS

Non-limiting and non-exhaustive examples are described with reference to the following Figures.

FIG. 1 is a schematic illustration of a planter in accordance with embodiments, including one or more aspects of the present disclosure and configured to plant seeds in a field.

FIG. 2 is a block diagram illustrating example physical components of a computing device with which aspects of the disclosure may be practiced.

FIG. 3 is a block diagram of a method for generating a shapefile that can be used by the planter, in accordance with embodiments.

FIG. 4 is a schematic illustration of a method for determining the discrete seeding rates used in planting, in accordance with embodiments.

FIGS. 5A and 5B show the generation of quantized final seeding distributions in accordance with embodiments. FIG. 5A is a final seeding distribution of a legume crop, such as soybeans, as a quantized graph with four intervals against field wetness. FIG. 5B is a final seeding distribution of a cereal crop, such as corn, as a quantized graph with four intervals against field wetness.

FIGS. 6A and 6B are two topographical wetness maps generated in accordance with embodiments. FIG. 6A is a topographical wetness map with a gradient legend. FIG. 6B is a simplified topographical wetness map with a simplified legend, illustrating four regions of the field within four intervals of wetness.

FIG. 7 is the visualization of a generated shapefile, with the regions of the graph color-coded with the assigned interval in the seeding rate distribution.

FIGS. 8A and 8B show the adjustment of discrete seeding rates. FIG. 8A is an adjustment in seeding rate of a legume crop, such as soybeans, against field wetness. FIG. 8B is an adjustment in seeding rate of a cereal crop, such as corn, against field wetness.

FIGS. 9A and 9B show generation of continuous final seeding distributions, in accordance with embodiments. FIG. 9A is a final seeding distribution of a legume crop, such as soybeans, as a continuous graph against field wetness. FIG. 9B is a final seeding distribution of a cereal crop, such as corn, as a continuous graph against field wetness.

### DETAILED DESCRIPTION

In the following detailed description, references are made to the accompanying drawings that form a part hereof, and in which are shown by way of illustrations, specific embodiments, or examples. These aspects may be combined, other aspects may be utilized, and structural changes may be made without departing from the present disclosure. Embodiments may be practiced as methods, systems, or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

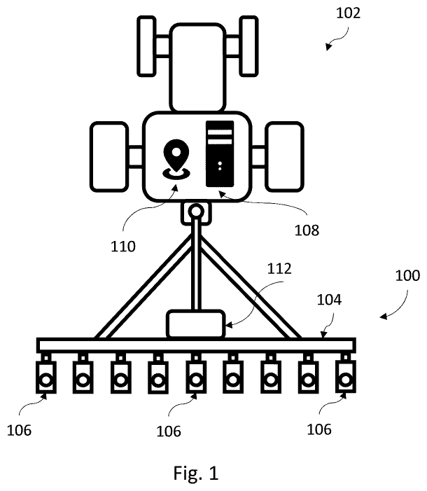

FIG. 1. is a simplified functional schematic of an exemplary multi-row planter 100 for use in planting seeds in a field and including one or more aspects of the present disclosure. As shown, a tractor 102 tows a planter 100 used for planting the seeds at varying rates. The seeds to be planted are stored in the seedbin 112. The tractor 102 is enabled with an on-board controller 108 for controlling a plurality of planting units 106 and a location monitoring system 110 such as an on-board GPS. While a tractor 102 is depicted, in other embodiments another suitable vehicle may be used. The planter 100 additionally includes a frame 104 supporting the plurality of planting units 106. These planting units 106 are controlled via the on-board controller 108 to plant seeds from the seedbin 112 at the rate desired, and may be configured to plant any desired type of seed (e.g., soybeans, corn, etc.) or any other small objects, without limitation. In the illustrated embodiment, the planter 100 includes nine planting units 106. However, in other embodiments, the planter 100 may include more than, or fewer than, nine planting units 106 within the scope of the present disclosure. A control system 108 is provided, which communicates with the location monitor 110, planter 100, and planting units 106 such that the rate at which seeds are planted changes, depending on the region of the field the tractor is in (e.g., as determined by the location monitoring system 110). In the illustrated embodiment, the control system 108 and location monitoring system 110 are located in the tractor 102. However, in other embodiments the control system 108 may be located otherwise on the planter 100, remote from the planter 100 and tractor 102, etc. In other embodiments, the controller 108 is configured to control one or more operations of the planter 100 (and/or the tractor 102) described herein (e.g., such that in some embodiments the planter 100 may be fully automated, may operate without human intervention, etc.).

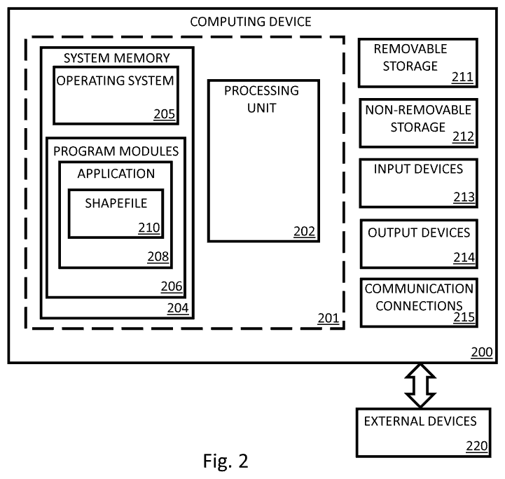

FIG. 2 is a block diagram illustrating physical components (e.g., hardware) of a computing device 200 with which aspects of the disclosure may be practiced. The computing device components described below, being connectable with external devices 220 and able to receive communication connections 215, may be suitable for the controller 108 described above, including management of the planter 100, planting units 106, and receipt of the location information 110, as discussed above with respect to FIG. 1. In a basic configuration, the computing device 200 may include at least one processing unit 202 and a system memory 204. Depending on the configuration and type of computing device, the system memory 204 may comprise, but is not limited to, volatile storage (e.g., random access memory), non-volatile storage (e.g., read-only memory), flash memory, or any combination of such memories.

The system memory 204 may include an operating system 205 and one or more program modules 206 suitable for running a software application 208 capable of receiving a shapefile 210 containing data defining the planting or seeding rate for each region or location of the field. The operating system 205, for example, may be suitable for controlling the operation of the computing device 200.

Furthermore, embodiments of the disclosure may be practiced in conjunction with other operating systems or any other application program and is not limited to any particular application or system. This basic configuration is illustrated in FIG. 2 by those components within a dashed line 201. The computing device 200 may have additional features or functionality. For example, the computing device 200 may also include additional data storage devices (removable and/or non-removable) such as, for example, magnetic disks, optical disks, or tape. Such additional storage is illustrated in FIG. 2 by a removable storage device 211 and a non-removable storage device 212.

As stated above, program modules and data files (e.g., the shapefiles described herein) may be stored in the system memory 204. While executing on the processing unit 202, the program modules 206 (e.g., application 208) may perform processes including, but not limited to, the aspects, as described herein. Other program modules that may be used in accordance with aspects of the present disclosure.

Furthermore, embodiments of the disclosure may be practiced in an electrical circuit comprising discrete electronic elements, packaged, or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 2 may be integrated onto a single integrated circuit. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

The computing device 200 may also have one or more input device(s) 213 such as a keyboard, a mouse, a pen, a sound or voice input device, a touch or swipe input device, etc. Output device(s) 214 such as a display, speakers, a printer, etc. may also be included. The aforementioned devices are examples and others may be used. The computing device 200 may include one or more communication connections 215 allowing communications with other external devices 220. Examples of suitable communication connections 215 include, but are not limited to, radio frequency (RF) transmitter, receiver, and/or transceiver circuitry; universal serial bus (USB), parallel, and/or serial ports. As an example, the location monitoring systems 110 may be obtained through on-board communications with the computing device 200 or as an external device connected through communication connections 215 (i.e., a USB GPS) or an external device 220 (i.e., a computer-aided GPS, on-board the tractor 102). Instructions for seeding rate, based on location of the tractor 102, may be sent to the planter 100 and planting units 106 through these communication connections 215 or through communications with other external devices 220.

The term computer readable media as used herein may include computer storage media. Computer storage media may include volatile and nonvolatile, removable, and non-removable media implemented in any method or technology for storage of information, such as computer readable instructions, data structures, or program modules. The system memory 204, the removable storage device 211, and the non-removable storage device 212 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information, and which can be accessed by the computing device 200. Any such computer storage media may be part of the computing device 200. Computer storage media does not include a carrier wave or other propagated or modulated data signal.

Communication connections 215 may be embodied by computer readable instructions, data structures, program modules, or other data in a modulated data signal, such as a carrier wave or other transport mechanism, and includes any information delivery media. By way of example, and not limitation, communication media may include wired media such as a wired network or direct-wired connection, and wireless media such as acoustic, radio frequency (RF), infrared, and other wireless media.

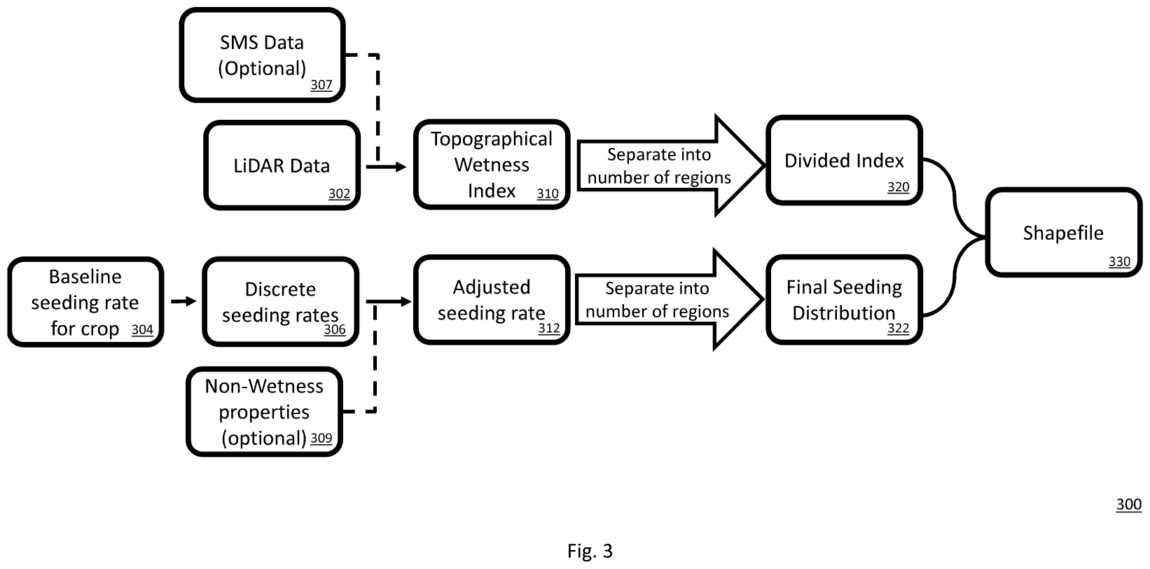

FIG. 3 is a schematic diagram of a method 300 for generating the shapefile 330 in accordance with embodiments. Publicly accessible LiDAR terrain data 302, optionally pre-processed SMS data 307, is gathered and used to generate a terrain-based feature map, one embodiment generating a Topographical Wetness Index 310. Using a given baseline seeding rate 304 for a specific crop, for example a seeding rate provided by the seed provider, a set of discrete seeding rates 306 are identified. Discrete seeding rate embodiments 306 described below use, for example the baseline seeding rate and other determined rates such as maximum and minimum seeding rates. In embodiments, the maximum seeding rate is the baseline plus a predetermined amount such as for example a percentage (i.e., 15-20%) or a specific number of seeds (i.e., 15-20 k seeds). In embodiments, the minimum seeding rate is the baseline minus a predetermined amount such as for example a percentage (i.e., 15-20%) or a specific number of seeds (i.e., 15-20 k seeds). The discrete seeding rates 306 are optionally adjusted, based on non-wetness features of the field 309 not used in generating the map (i.e., pH value), resulting in a final adjusted seeding rate 312.

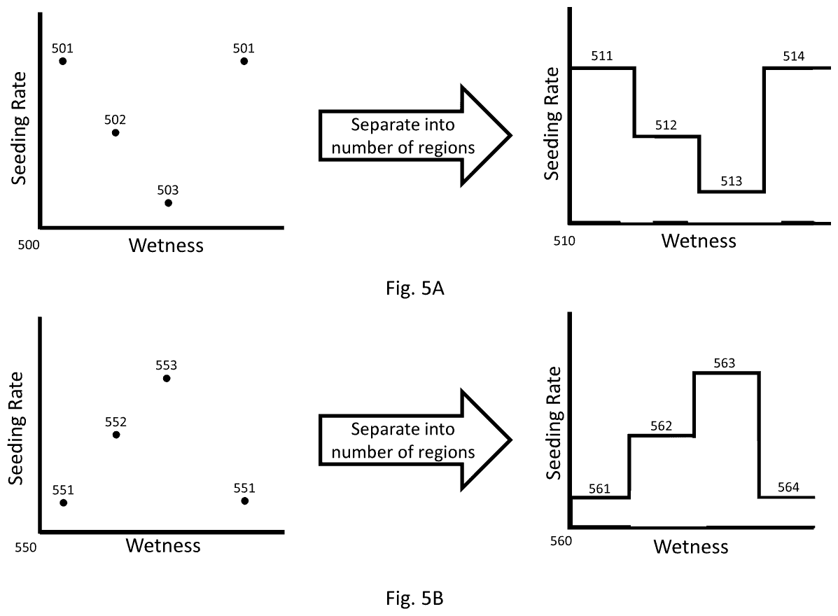

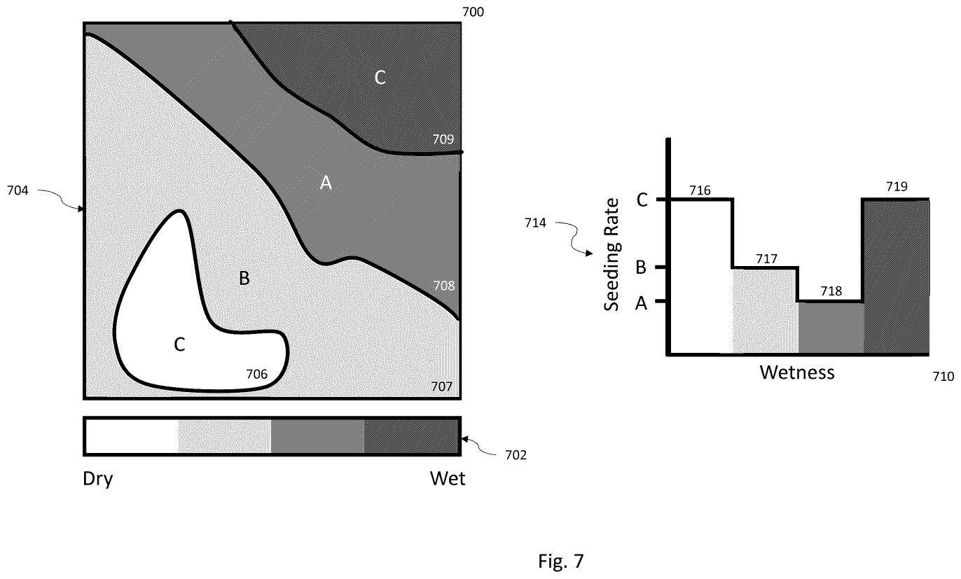

In embodiments, both the wetness index 310 and the adjusted seeding rates 312 are separated into a predetermined and equivalent number of regions. The number of regions may be arbitrary. For example, in the embodiments illustrated and described in connection with FIG. 5 and FIG. 7 the wetness index 310 and the adjusted seeding rate 312 are divided into four discrete regions. The wetness index 310 when divided forms a simplified divided index 320 grouping the regions of the field by similarity, with respect to their relative wetness. The adjusted seeding rate 312 when divided forms a final seeding distribution 322. The final seeding distribution 322 is then associated with the associated regions of the field in the divided index 320 through a unique shapefile 330. This shapefile 330 is stored on the controller 108 and used to identify the seeding rate for the planter 100 to use based on the planter's location in the field. This allows for variable seed rate planting of the given field, considering in field variables, without using in-field or on-board monitors for soil conditions or other field characteristics.

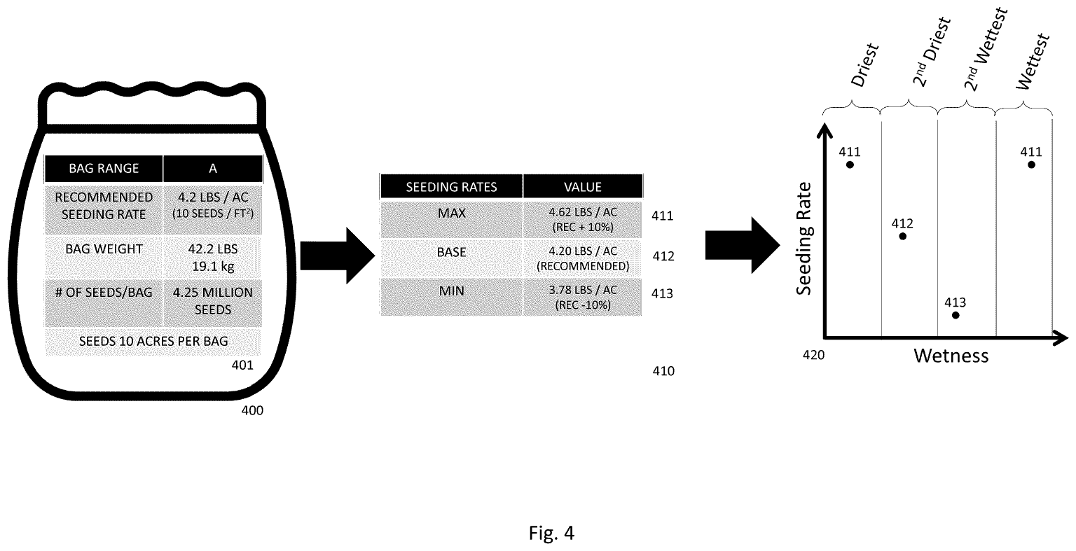

FIG. 4 is a schematic illustration of the method for determining the discrete seeding rates used in planting. In the illustrated embodiment, from the seed bag 400, a table of figures 401 are provided containing a recommended seeding rate 402 from the seed provider, which may be used as the previously mentioned baseline seeding rate 304. Other embodiments may use other rates as a baseline rate. In the illustrated embodiment, a set of discrete seeding rates 410 are identified. The recommended seeding rate 402 is assigned as the baseline seeding rate 412, while the maximum seeding rate 411 is identified as the baseline rate plus 10%, and the minimum seeding rate 413 is identified as the baseline rate minus 10%. This set of discrete seeding rates is then plotted against wetness 420, and in the illustrated embodiment is plotted in a U-shaped bimodal pattern. In the embodiments shown in FIG. 4, the U-shaped bimodal pattern results from placing these seeding rates, such that the maximum seeding rate 411 is placed in the wettest and driest regions, the minimum seeding rate 413 is placed in a region of median wetness, such as for example the second wettest region, and the baseline seeding rates 412 lie between the maximum and the minimum, such as the second driest region. This U-shaped bimodal pattern in this embodiment derives from overseeding overly dry and overly wet soil, to overcome poor yield within those regions, while seeding high quality soil with fewer seeds, to maximize their spacing and their yield. For a cereal crop (i.e., corn) these seeding rates may be an inverted U-shaped bimodal pattern.

FIG. 5A shows the conversion for a legume crop (e.g., soybeans) of the prior set of discrete seeding rates 500 to a final seeding distribution 510 depicted as a quantized, stepwise graph. The final seeding distribution 510 is formed such that, for a number of intervals corresponding to the number of regions of the field, each interval has a constant seeding rate. For the number of regions in the field desired, intervals along the domain are identified. These intervals are then assigned a uniform seeding rate. In the illustrated embodiment, the seeding rate in the first and fourth regions 511, 514 is the previously identified maximum seeding rate 501, the baseline seeding rate 502 is used in the second-from-driest region 512, and the minimum seeding rate 503 is used in the second-from-wettest region 513. FIG. 5B shows the conversion for a cereal crop (e.g., corn) of a set of discrete seeding rates 550 to a final seeding distribution 560 depicted as a quantized, stepwise graph, for a cereal crop (e.g., corn). The final seeding distribution 560 is formed such that, for a number of intervals corresponding to the number of regions of the field, each interval has a constant seeding rate. In the illustrated embodiment, the seeding rate in the first and fourth regions, 561 and 564, is the previously identified minimum seeding rate 551. In the illustrated embodiment, the lower, baseline seeding rate 552 is used in the second-from-driest region 562, and the higher, maximum seeding rate 553 is used in the second-from-wettest region, 563. In both of the illustrated embodiments, the intervals are equivalent in size. In embodiments, the intervals may be differently sized. In the illustrated embodiment, being a quantized stepwise graph, seeding rates only change at the boundaries of the regions. If two regions should be assigned the same seeding rate (e.g., having an extremum equivalently between them, having equivalent extrema, etc.), but they cannot be assigned the same seeding rate, the seeding rates are assigned based on predetermined criteria. In one embodiment, for example, when assigning seeding rates of soybeans, the wetter region is assigned the lower seeding rate, and the drier region is assigned the higher seeding rate.

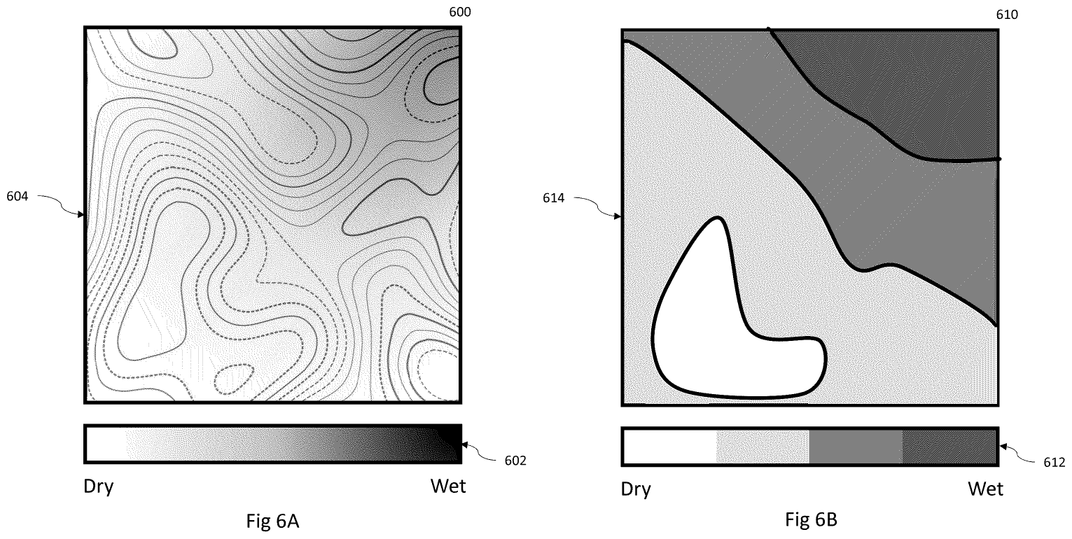

FIG. 6A is an exemplary graphical illustration of a continuous topographical feature map 600 of a field, while FIG. 6B, using the same field, is a graphical illustration of a segmented topographical feature map 610, separated into four regions of similar wetness. In the FIG. 6A instance, the field 604 shows a continuous gradient corresponding to a location's topographical wetness index value, also known as the wetness potential layer for the soil. The shade of the gradient corresponds to the relative wetness of the given field, as seen in the legend 602. For one embodiment using soybeans, an average wetness value is associated with higher field quality, however other features may relate differently with field quality for other row crops. FIG. 6B is a graphical illustration of a segmented topographical feature map 610, with both the field 614 and the legend 612 separated into four intervals of wetness values. The separation of this field into four regions is an arbitrary and non-limiting distinction; one could, for example, separate the field into three, five, ten, or any number of regions. In the illustrated embodiment, the regions depicted in the field 614 are enclosed and not interspersed with one another, however this is non-limiting, and the regions may be topologically different such as being open, interspersed with one another, etc. (i.e., a wet patch may appear in an otherwise dry area.)

FIG. 7 is a visualization of a generated shapefile. The shapefile, being a seeding distribution 710 where each constant seeding rate in the set of seeding rates 714 is associated with a location in a field 704, allowing the controller 108 (FIG. 1) to identify the seeding rate to be used for that location. The controller, when querying for a seeding rate 714, uses the location monitoring system 110 (FIG. 1) to identify what region of the field 704 it is in. Once identified, the seeding rate for that region is returned. In the illustrated embodiment, for the driest region 706 the maximum seeding rate C is returned 719. Additionally, for the wettest region 709 the maximum seeding rate C is returned 719. For the second-from-driest region 707, the higher, baseline seeding rate B is returned 717. For the second-from-wettest region 708, the lower, below baseline seeding rate A is returned 718.

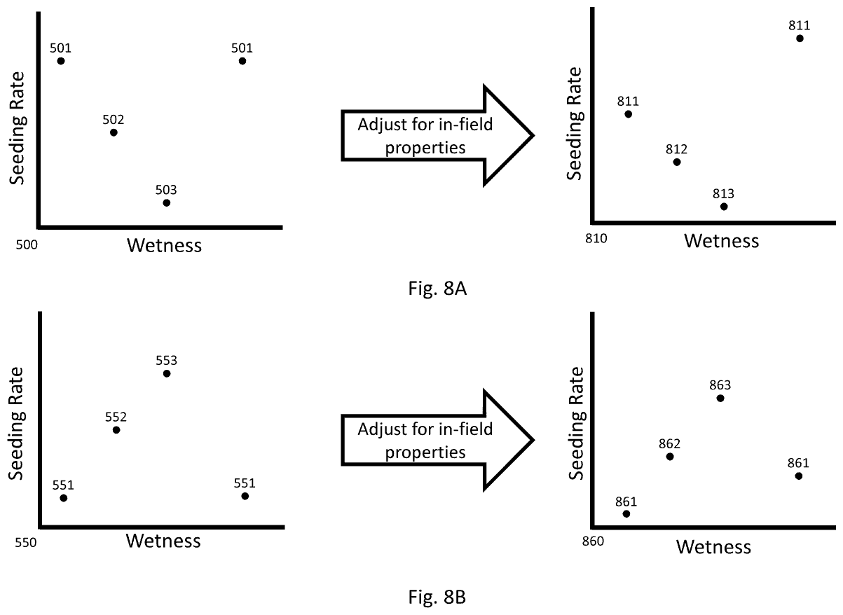

FIG. 8 shows the adjustment of the set of discrete seeding rates of row crops to account for other in-field features (e.g., pH, altitude, etc.). The illustrated embodiment of FIG. 8A depicts the previously discussed seeding rates graphed against wetness 500, depicting a U-shaped bimodal distribution typical of legume crops (e.g., soybeans) with two maxima 501 with equivalent maximum seeding rates, as well as one minimum 503. In one embodiment, after being adjusted for an in-field property this curve retains the “U” shape 810 but now with disparate maxima 811 and an unchanged minimum 813. Due to this adjustment, the previously identified baseline seeding rate may no longer be equivalent to the average seeding rate. The illustrated embodiment of FIG. 8B of the seeding rate graphed against wetness 550 depicts the previously discussed inverted version of the curve seen in 8A, which is more typical of cereal crops (e.g., corn) with one maximum 553 and two minima 551 with equivalent minimum seeding rates. In one embodiment, after being adjusted for an in-field property this curve retains the inverse shape 860 but now with disparate minima 861 and a changed, lower maximum 863. Due to this adjustment, the previously identified baseline seeding rate may no longer be equivalent to the average seeding rate. These adjustments are non-limiting; other embodiments may result in changing the magnitude of the extrema, creating disparate extrema, changing the number of extrema, changing the continuity of the graph, etc.

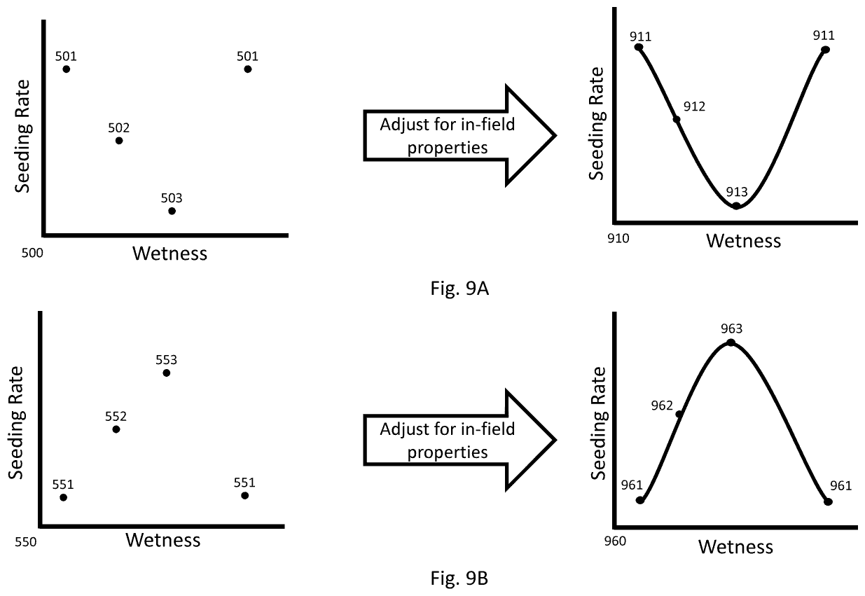

FIG. 9A shows the conversion of the prior set of discrete seeding rates 500 to a continuous final seeding distribution 910 depicted as a continuous, U-shaped bimodal graph, approximating intermediate seeding rates between the minimum 913, baseline 912, and maximum 911 on the curve. The final seeding distribution 910 may, for example, be formed following conventional curve-fitting techniques (i.e., regression) and defined such that it passes through the set of discrete points determined as described above. FIG. 9B shows the conversion of the prior set of discrete seeding rates 550 to a final seeding distribution 960 depicted as a continuous, inverted U-shaped bimodal graph, approximating intermediate seeding rates between the minimum 961, baseline 962, and maximum 963 on the curve. The final seeding distribution 960 is formed following conventional curve-fitting techniques (i.e., regression) and defined such that it passes through the set of discrete points.

The invention of this application has been described above both generically and with regard to specific embodiments. It will be apparent to those skilled in the art that various modifications and variations can be made in the embodiments without departing from the scope of the disclosure. Thus, it is intended that the embodiments cover the modifications and variations of this invention provided they come within the scope of the appended claims and their equivalents

1. Agricultural equipment, comprising:
a planter for planting crop seeds;
a GPS receiver for receiving field location data; and
a computer system coupled to the planter and the GPS receiver, including:
memory for storing a shapefile, wherein the shapefile defines seeding rate as a function of field location, and wherein the seeding rate is a distribution based upon wetness levels; and
a processor for controlling the planter based upon the field location data and the shapefile.

2. The agricultural equipment of claim 1, wherein the shapefile defines a bimodal distribution of seeding rates as a function of wetness levels.

3. The agricultural equipment of claim 2, wherein the bimodal function includes a U-shaped bimodal function or an inverted U-shaped bimodal function.

4. A computer-implemented method, comprising:
receiving, by one or more processors, topographical wetness index data representative of wetness levels at locations on an agricultural field;
receiving, by the one or more processors, a baseline seeding rate of a crop to be planted on the agricultural field; and
generating, by the one or more processors, a seeding distribution function for the agricultural field based upon the topographical wetness index data and the baseline seeding rate, wherein the seeding distribution function is a function describing seeding rate as a function of wetness levels.

5. The computer-implemented method of claim 4, wherein the seeding distribution function is a U-shaped bimodal function.

6. The computer-implemented method of claim 5, wherein the seeding distribution function has two relative maximums and a minimum.

7. The computer-implemented method of claim 6, wherein the two relative maximums are greater than the baseline seeding rate, and the minimum is less than the baseline seeding rate.

8. The computer-implemented method of claim 6, wherein the two relative maximums are the same.

9. The computer-implemented method of claim 4, wherein the seeding distribution function is a discrete function comprising a plurality of discrete seeding rates associated with discrete wetness level zones.

10. The computer-implemented method of claim 9, wherein the seeding distribution function includes three discrete seeding rates, including a first seeding rate corresponding to the baseline seeding rate, two second seeding rates corresponding to an amount greater than the baseline seeding rate by a first predetermined amount, and a third seeding rate corresponding to an amount less than the baseline seeding rate by a second predetermined amount.

11. The computer-implemented method of claim 10, wherein the first and second predetermined amounts are percentage values.

12. The computer-implemented method of claim 11, wherein the first and second predetermined amounts are the same percentage values.

13. The computer-implemented method of claim 4, wherein the seeding distribution function is a continuous function.

14. The computer-implemented method of claim 4, wherein the crop is a row crop, optionally a legume crop, and optionally soybeans.

15. The computer-implemented method of claim 5, wherein the bimodal distribution function is an inverse U-shaped function.

16. The computer-implemented method of claim 16, wherein the bimodal distribution function has two relative minimums and a maximum.

17. The computer-implemented method of claim 15, wherein the crop is a row crop, optionally a cereal crop, and optionally corn.

18. The computer-implemented method of claim 4, wherein:
the method further comprises receiving, by the one or more processors:
Lidar data for the field; and
terrain analysis data for the field; and
generating the topographical wetness index data comprises generating the topographical wetness index data based upon the Lidar data and the terrain analysis data.

19. The computer-implemented method of claim 4, further comprising:
receiving, by the one or more processors, field location data, optionally GPS data; and
generating, by the one or more processors based upon the field location data and the seeding distribution function, a shapefile representative of seeding rate based on location in the field.

20. The computer-implemented method of claim 19, further comprising transmitting the shapefile to a computer system of agricultural equipment configured to plant the crop.

21. The computer-implemented method of claim 20, further comprising:
receiving, by the computer system of the agricultural equipment, location data representative of a location of the agricultural equipment on the field, optionally GPS data; and
operating the computer system of the agricultural equipment based upon the location data and the shapefile to plant the crop.
